(19) United States
(12) Patent Application Publication
(10) Pub. No.: US 2016/0048153 A1
(43) Pub. Date: Feb. 18, 2016

(54) MODULAR SYSTEM OF AN OPERATING DEVICE

(71) Applicant: MAHLE INTERNATIONAL GMBH, Stuttgart (DE)

(72) Inventors: Sebastian De La Coba Denninger, Ludwigsburg (DE); Ulrich Deusser, Erzhausen (DE); Christoph Hipp-Kalthoff, Stuttgart (DE); Hans-Henning Knorr, Remshalden (DE); Klaus Voigt, Bietigheim-Bissingen (DE)

(21) Appl. No.: 14/782,242

(22) PCT Filed: Mar. 19, 2014
(86) PCT No.: PCT/EP2014/055522

§ 371 Date: Oct. 2, 2015

(30) Foreign Application Priority Data
Apr. 3, 2013 (DE) 10 2013 205 884.5

(51) Int. Cl. G05G 1/01; G05G 1/10

(52) U.S. Cl. CPC G05G 1/01; G05G 1/105

(57) ABSTRACT

A modular system of an operating device may include at least one base housing having at least two receiving units. Each receiving unit may have mounted therein a rotatable operating element. The rotatable operating element may include at least one of a mechanical assembly for adjusting Bowden cables, an electronic device for recognizing a position of the mechanical assembly, and an electromechanical rotary regulator.

### CROSS REFERENCE TO RELATED APPLICATIONS

This application claims priority to German Patent Application No. 10 2013 205 884.5, filed Apr. 3, 2013, and International Patent Application No. PCT/EP2014/055522, filed Mar. 19, 2014, both of which are hereby incorporated by reference in their entirety.

### TECHNICAL FIELD

The present invention relates to a modular system of an operating device, in particular for heating or air-conditioning the inner chamber of a vehicle. The invention also relates to an operating device constructed from such a modular system.

### BACKGROUND

Operating devices are sufficiently known in modern motor vehicles and serve in particular for controlling or respectively regulating the temperature. Such an operating device therefore serves for example for adjusting the air-conditioning system, in particular the temperature or respectively the ventilation performance.

A disadvantage in known operating devices, however, is that these are configured individually for each fitting line and for each vehicle type, whereby for all fitting lines often a plurality of different operating devices must be held available, which requires a not inconsiderable logistical expenditure and investments in tools and devices.

### SUMMARY

The present invention is therefore concerned with the problem of eliminating the known disadvantages from the prior art in connection with such operating devices.

This problem is solved according to the invention by the subjects of the independent claims. Advantageous embodiments are the subject of the dependent claims.

The present invention is based on the general idea of no longer constructing and therefore holding available a particular operating device for each fitting variant of a motor vehicle, as hitherto, but rather of assembling such operating devices for the most varied of fitting variants of the motor vehicles individually and flexibly by means of a suitable modular system. The modular system according to the invention therefore permits the production of the most varied of operating devices, using the most varied of components, which operating devices are then able to be installed into the respective motor vehicles. The modular system according to the invention for an operating device comprises here at least one base housing, which can be basically in one piece or assembled from at least two housing parts, here a front and a rear housing part. The base housing contains at least two receiving units, preferably three receiving units, in which respectively a rotatable operating element, for example a mechanical assembly for adjusting Bowden cables, an electronic device for recognizing the position of the rotary knob and/or an electromechanical rotary regulator, can be mounted, and a printed circuit board, which contains in particular the electronic components of the operating part. The mechanical assembly can comprise here a rotary knob for a Bowden cable, wherein a potentiometer can come into consideration for a rotary regulator. In addition, the modular system can contain a cover element for covering an unused receiving unit of the base housing. The base housing is therefore, for example, able to be equipped with only one potentiometer, wherein in this case the other receiving unit(s) are covered by means of corresponding cover elements. It is likewise conceivable that in a higher fitting variant for example, all receiving units are occupied, in particular with one or more potentiometers, one or more rotary regulators and one or more rotary knobs for a Bowden cable. With the modular system according to the invention it is therefore possible to react in a simple and particularly flexible manner to the most varied of fitting requirements and to realize the most varied of fitting wishes by a suitable combination of the elements of the modular system.

Expediently, the modular system has at least one facing element for cladding the base housing. Here, the most varied of facing elements, for example of plastic, wood or metal, can be provided, whereby in turn the most varied of fitting variants and in particular also the most varied of quality requirements can be met. It is conceivable here that for example a facing element made from plastic represents a comparatively cost-efficient and robust alternative for a simple fitting variant, whereas for example a facing element of polished wood, plastic, in particular silicone, or aluminium meets a rather higher quality requirement. By holding available the most varied of facing elements, the variant formation of the operating device can be further increased by means of the modular system according to the invention.

Expediently, three receiving units are provided, which are arranged linearly or in a triangular arrangement on the base housing. Hereby, a geometric, functional and therefore also clearly laid-out arrangement of the individual receiving units and hence also of the individual operating elements, such as for example potentiometer, rotary regulator or rotary knob, can be achieved. The receiving units and the operating elements are always constructed here so that individual operating elements or respectively the cover element can be received alternatively in a receiving unit. In addition to a linear and triangular arrangement, any other possible arrangements are also conceivable for the modular system.

In a further advantageous embodiment of the solution according to the invention, the base housing has at least one further receiving unit for a pressure switch. In addition to the rotatable operating elements, such as for example potentiometer, rotary knob for a Bowden cable or rotary regulator, therefore also the arranging of pressure switches or respectively push-buttons is also conceivable, by means of which further functions are able to be controlled via the operating device.

In a further advantageous embodiment of the solution according to the invention, the potentiometer, the rotary regulator or the rotary knob, i.e. generally the rotatable operating element, is connected with the front housing part by means of a snap-on connection, i.e. is locked into position. Such snap-on connections can be realized in a simple manner by means for example of detent noses arranged on the rotatable operating element, which engage behind a corresponding undercut or respectively edge on the receiving unit on the housing side. Through such snap-on connections, in particular the mounting of the rotatable operating elements on the front housing part can be distinctly simplified. In addition, the possibility exists to align the individual assemblies in various positions and angles on the base housing by positioning aids, in particular a guide track or positioning nose. Thus, in particular for the mechanical group for adjusting a Bowden cable, various possible catch arrangements exist, in order to arrange the outlet of the Bowden cable in a targeted manner in different installation situations.

Expediently, the modular system has a printed circuit board on which, in addition to the electronic components, a lighting arrangement, in particular with LEDs, is arranged for lighting the rotatable operating elements. In order, in particular, to also be able to ensure a reliable operating of the operating device at night, it is necessary to illuminate the individual operating elements, for example the rotatable operating elements or else the pressure switches, so that a user can find these reliably and easily. Through LEDs, the lighting can, moreover, be realized in a favourable manner as regards energy and with almost any desired choice of colour. In addition, such LEDs have a comparatively long service life, so that for example they do not have to be replaced and function over the entire service life of the motor vehicle.

Further important features and advantages of the invention will emerge from the subclaims, from the drawings and from the associated figure description with the aid of the drawings.

It shall be understood that the features mentioned above and to be explained further below are able to be used not only in the respectively indicated combination, but also in other combinations or in isolation, without departing from the scope of the present invention.

Preferred example embodiments of the invention are illustrated in the drawings and are explained in further detail in the following description, wherein the same reference numbers refer to identical or similar or functionally identical components.

### BRIEF DESCRIPTION OF THE DRAWINGS

There are shown here, respectively diagrammatically

FIG. 1 an operating device assembled by means of a modular system according to the invention, in a lateral view and a top view according to a first embodiment,

FIG. 2 an illustration as in FIG. 1, but with an alternative assembly,

FIG. 3 a top view onto an operating device according to the invention, with rotatable operating elements removed,

FIG. 4 a top view onto the operating device with LEDs for realizing an illumination,

FIG. 5 a modular system according to the invention for the assembly of individual operating devices.

### DETAILED DESCRIPTION

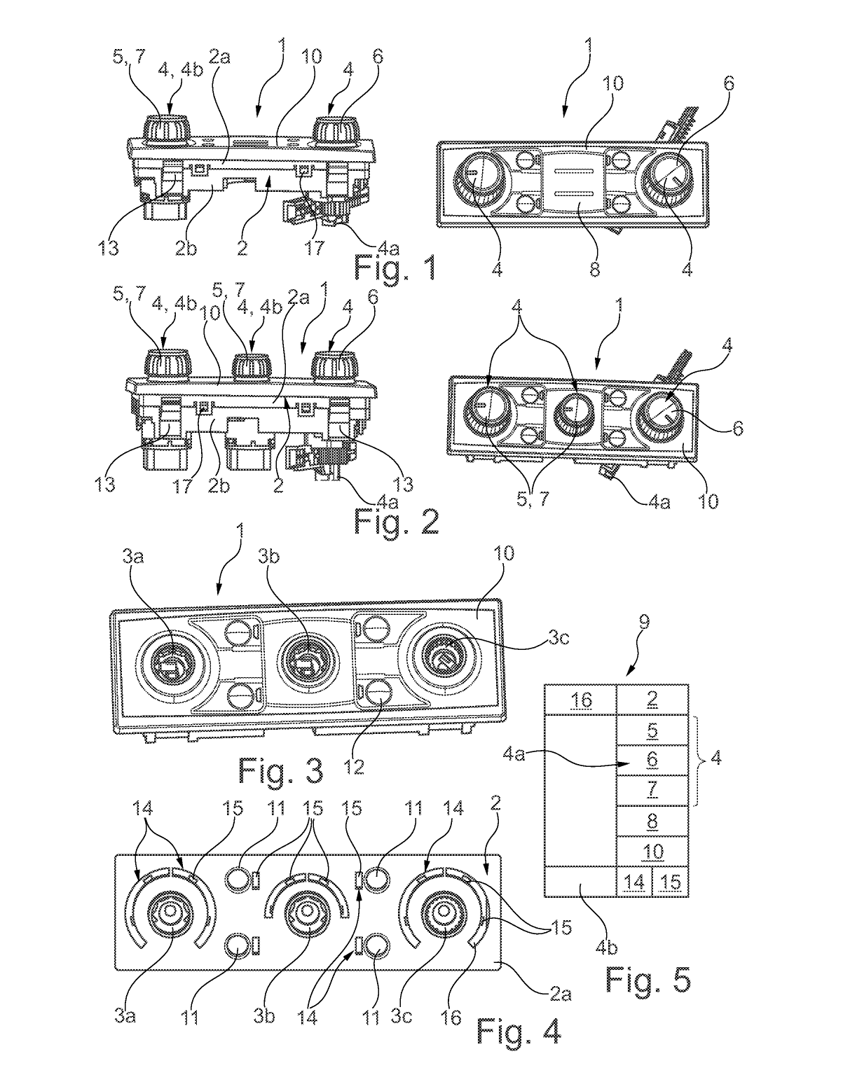

According to FIGS. 1 to 3, an operating device 1 according to the invention, in particular for heating or air-conditioning an inner chamber of a vehicle, has a base housing 2, which consists of two housing parts, namely a front housing part 2a and a rear housing part 2b which is able to be locked into position therewith. In the front housing part 2a, three receiving units 3a, 3b and 3c are provided, in which respectively a rotatable operating element 4, in particular a mechanical assembly 4a for adjusting Bowden cables, for example a rotary knob 6, an electronic device 4b for recognizing the position of the rotary knob and an electromechanical rotary regulator 7, in particular a potentiometer 5, can be mounted. Generally, the base housing 2 has at least two receiving units 3a, 3b, 3c. The front and rear housing part 2a, 2b can be connected with one another here via a clip connection 17. Of course, it is also conceivable here that the housing 2 consists of more than two housing parts 2a, 2b or else consists only of a single housing part, wherein in the latter case it is constructed in the manner of a plate.

If one of the receiving units 3a, 3b or 3c is not required for a corresponding rotatable operating device 4, it can be covered by a corresponding cover element 8 (cf. FIG. 1). Alternatively, a tool insert can also be used, which closes the unused receiving unit 3a, 3b and/or 3c during injection moulding.

In order to now be able to manufacture such an operating element 1 as flexibly as possible and therefore also economically, the operating element 1 according to the invention is assembled by means of individual components of a modular system 9 (cf. FIG. 5) individually and according to requirement, for example according to the fitting variant of the vehicle. Such a modular system 9 according to the invention comprises here at least one base housing 2 with at least two, preferably three receiving units 3a, 3b and 3c, in which respectively a rotatable operating element 4, in particular a mechanical assembly 4a for adjusting Bowden cables, for example a rotary knob 6, an electronic device 4b for recognizing the position of the rotary knob and an electromechanical rotary regulator 7, in particular a potentiometer 5, can be mounted. Furthermore, the modular system 9 comprises at least one cover element 8 for covering an unused receiving unit 3a, 3b or 3c of the base housing 2. With this modular system 9, the most varied of fitting variants can now be assembled comparatively so that they do not have to be manufactured separately and held available accordingly as hitherto.

Furthermore, the modular system 9 can have at least one facing element 10 for cladding the base housing 2. Such a facing element 10 can be produced for example from plastic, from wood or else also from metal and can thereby be adapted individually to the most varied of fitting variants or respectively fitting lines. Thus, in particular, the use of a facing element 10 made from plastic is conceivable in a simple fitting variant or respectively line, whereas facing elements 10 of polished wood or polished metal are provided for higher-quality fitting lines.

Observing FIGS. 1 to 4, it can be seen that the receiving units 3a, 3b and 3c are arranged linearly on the base housing 2. Furthermore, the front housing part 2a of the base housing 2 can have at least one further receiving unit 11 for receiving a pressure switch 12. In the embodiments which are shown, the operating device 1 has respectively four receiving units 11 and four associated pressure switches 12. The receiving units 11 here are arranged and symmetrically distributed respectively between other receiving units, for example between the receiving unit 3a and the receiving unit 3b, whereby a visually attractive configuration is produced. For connecting the rotatable operating element 4, i.e. for example the potentiometer 5, the rotary regulator 7 or the rotary knob 6, a snap-on connection 13 can be provided, whereby the mounting of the respective rotatable operating element 4 can be brought about by a simple pressing in and locking into position with a printed circuit board 16. On the printed circuit board 16, furthermore, a lighting arrangement 14 with the most varied of LEDs 15 can be arranged, which in particular enable a pleasant background illumination of the respective operating elements 4 or respectively of the pressure switches 12, and thereby also improve the operation in poor visibility conditions. The lighting arrangement 14 or respectively the LEDs 15, like the printed circuit board 16, can be a component part here of the respective modular system 9. Push-buttons, an ice protection, an actuator control, an evaluation arrangement for signals, an electronic device for recognizing the position of the rotary knob, a rotary switch, a processor, a power supply etc. for example can be additionally housed in the printed circuit board 16.

With the modular system 9 according to the invention therefore an operating device 1 can be adapted individually and comparatively flexibly to the most varied of requirements, so that also for the most varied of fitting lines of different motor vehicles particular operating devices 1 do not respectively have to be held available, but rather these can be assembled respectively individually from the modular system 9 according to the invention. Hereby, in particular the storage, logistics and development and tool costs can be distinctly reduced, and a distinctly increased flexibility can be achieved in the production of the operating device 1.

1. A modular system of an operating device, comprising:
at least one base housing with at least two receiving units in each of which a rotatable operating element is mountable, the rotatable operating element including at least one of:
a mechanical assembly for adjusting Bowden cables,
an electronic device for recognizing a position of the mechanical assembly, and
an electromechanical rotary regulator.

2. The modular system according to claim 1, further comprising a printed circuit board containing electronic components of at least one of the rotatable operating elements.

3. The modular system according to claim 1, further comprising at least one cover element for covering an unused receiving unit of the at least two receiving units.

4. The modular system according to claim 1, further comprising at least one facing element for cladding the base housing.

5. The modular system according to claim 1, wherein the base housing has a front housing part and a rear housing part able to be clipped together via a clip connection, wherein the receiving units are arranged on the rear housing part.

6. The modular system according to claim 5, wherein the front housing part of the base housing includes at least one further receiving unit for a pressure switch.

7. The modular system according to claim 6, wherein the at least one further receiving unit is arranged between two receiving units for the rotatable operating elements.

8. The modular system according to claim 1, wherein at least one rotatable operating element is lockable into position with the base housing by a snap-on connection.

9. The modular system according to claim 1, wherein the rotatable operating elements are able to be aligned by at least one positioning aid on the base housing.

10. The modular system according to claim 2, wherein on the printed circuit board a lighting arrangement is arranged for illuminating at least one of the mechanical assembly, the electronic device, and the rotary regulator.

11. An operating device comprising:
a modular system having a two-part base housing with at least two receiving units; and
at least two rotatable operating elements each mounted in one of the receiving units, the at least two rotatable operating elements including at least one of:
a mechanical assembly for adjusting Bowden cables,
an electronic device for recognizing a position of the mechanical assembly, and
an electromechanical rotary regulator.

12. The operating device according to claim 11, further comprising at least one cover element for covering an unused receiving unit.

13. The operating device according to claim 11, wherein the at least two receiving units are constructed identically, so that any one of a rotary regulator and a mechanical assembly is able to be arranged in either of the at least two receiving units.

14. The modular system according to claim 1, wherein the electromechanical rotary regulator is a potentiometer.

15. The modular system according to claim 2, characterized in that further comprising at least one cover element for covering an unused receiving unit.

16. The modular system according to claim 2, wherein the base housing has a front housing part and a rear housing part able to be clipped together via a clip connection, wherein the receiving units are arranged on the rear housing part.

17. The modular system according to claim 16, wherein on the front housing part of the base housing at least one further receiving unit for a pressure switch is present.

18. The modular system according to claim 6, wherein on the printed circuit board a lighting arrangement is arranged for illuminating at least one of the mechanical assembly, the electronic device, the rotary regulator, and the pressure switch.

19. The modular system according to claim 5, wherein at least one rotatable operating element is lockable into position with the base housing by a snap-on connection.

20. The modular system according to claim 5, wherein the base housing includes at least one positioning aid by which at least one rotatable operating element is able to be aligned.
